(19) United States
(12) Patent Application Publication
(10) Pub. No.: US 2012/0032981 A1
(43) Pub. Date: Feb. 9, 2012

(54) Electronic Book With Configurable Display Panels

(75) Inventor: Samuel C. Hackwell, Lynden, WA (US)

(73) Assignee: Tina Hackwell, Lynden, WA (US)

(21) Appl. No.: 12/850,261

(22) Filed: Aug. 4, 2010

(51) Int. Cl. G09G 5/00

(52) U.S. Cl. 345/650

(57) ABSTRACT

An electronic book capable of being configured of multiple display panels. Display panels having two-sided hinging capabilities—right and left sides of housing, wherein a user can add multiple display panels and hinge them together in various configurations. The display panels can be of various sizes and shapes, and are foldable upon each other when hinged together and being able to be rotated from 0° to 360°. Both images within the displays and the display panels themselves can be viewed and configured in a portrait orientation, or a landscape orientation, or an “Alarm Clock” orientation. Images can be rotated clockwise or counterclockwise depending upon signal input. Images can be also be “stretched” across multiple display panels. The electronic book is capable but not limited to the storing and presenting of electronic media such as, ebooks, ejournals, enewspapers, emagazines, video, and sound. Electronic book display panels can communicate over a network.

### FIELD OF INVENTION

The present invention relates generally to electronic books.

### BACKGROUND OF THE INVENTION

Electronic books (eBooks) are electronic reading devices wherein a person can read electronic book files, electronic journals, electronic magazines, electronic newspapers, and other forms of electronic text and images files, including viewing video, including the ability to listen to audio and music files which are stored on a storage medium in a housing. Multiple electronic books and files are stored on the storage medium. All forms of media within the storage medium within the device can be presented on the display of the housing. The purpose of an electronic book is to allow a user to transport a very large number of books, journals, magazines, newspapers, text, images, video, music, etc., in a very small and lightweight form factor. The ability to add display panels at will, allows users the advantage to view multiple displays and media, such as viewing multiple books at once or multiple pages at once, or view expanded and enlarged images “stretched” across multiple display panels, simultaneously. Display panels can be configured and arranged side by side in a portrait mode, or rotated by signal input. Images can be rotated or stretched or manipulated by user to display across one or multiple displays in various orientations and configurations. Also, with each display panel can vary in size and shape and thickness.

### SUMMARY OF THE INVENTION

An electronic book display panel includes a housing and a touch screen display panels which is supported on the housing. The “ebook” can be composed of multiple touch screen display panels hinged together. A digital processor in the housing which controls the image and sound presentation on the display panels and wireless connection, communication and synchronization of display panels. A digital storage medium accessible by the processor, which stores all media files. The processor receives a display mode change signal either automatically through the physical rotation which triggers the accelerometer or through the touch screen gestures or physical touch of the screen, or by voice command, thereby changing viewing mode, whether portrait or landscape or “Alarm Clock” mode.

The embodiments of the housing of the display panels can hinged on both the right and left sides, and thus multiple display panel housings can be hinged together and folded and viewed in various configurations and display modes. Hinges allow for full 0° degree rotation through 360° rotation.

In another aspect, each electronic book display panel includes the same as described in 0003, and can be hinged together and can be remotely accessed by the processor and communicate together over a network.

The details of the present invention, both as to its structure and interpretation, can be best understood in reference to the accompanying drawings, in which reference numerals refer to like parts, and in which:

### BRIEF DESCRIPTION OF THE DRAWINGS

FIG. 1 is a perspective view of an example of an electronic book display panel, showing exterior and interior sides, including the labeling of hinges on both right and left side of the panels;

FIG. 2 is a perspective view showing two display panels of FIG. 1 in a closed configuration;

FIG. 3 is a perspective view showing three display panels of FIG. 1 in a closed configuration;

FIG. 4 is a perspective view showing four display panels of FIG. 1 in a closed configuration;

FIG. 5 is a perspective view showing five plus panels of FIG. 1 in a closed configuration;

FIG. 6 is a perspective view showing a display panel of FIG. 1 in a single portrait orientation;

FIG. 7 is a perspective view showing two display panels of FIG. 1 in a book portrait open orientation and configuration;

FIG. 8 is a perspective view showing three display panels of FIG. 1 hinged together in a book portrait open orientation and configuration;

FIG. 9 is a perspective view showing four display panels (or more) of FIG. 1 hinged together in a book portrait open orientation and configuration;

FIG. 10 is a perspective view showing two display panels of FIG. 1 in an open position along with folding of panels into a closed position;

FIG. 11 is a perspective view showing three display panels of FIG. 1 in an open position along with folding of panels into a closed position;

FIG. 12 is a perspective view showing four display panels of FIG. 1 in an open position along with folding of panels into a closed position;

FIG. 13 is a perspective view showing two display panels of FIG. 1 in an open landscape “Alarm Clock” orientation and configuration;

FIG. 14 is a perspective view showing two display panels of FIG. 1 showing full rotation of a display panel folded from 0° degrees (closed) to a full 360° degrees folded back onto the second panel in an open position and configuration. Display panels can stopped and viewed at any rotational degree the user chooses;

FIG. 15 is a perspective view showing two display panels of FIG. 1 in landscape orientation and configuration;

FIG. 16 is a perspective view showing four display panels of FIG. 1 in landscape orientation and configuration. Images of two opposing display panels can be viewed arranged degrees to the other two panels. This configuration allows for two or more users.

FIG. 17 is a schematic diagram showing two or more display panels of FIG. 1 in a portrait mode orientation with images viewed side by side in parallel or image is stretched across two or more displays;

FIG. 18 is a schematic diagram showing two or more display panels of FIG. 1 in a landscape mode orientation with images viewed in a “stacked” one over the other in parallel, while the image can be stretched across two or more displays;

FIG. 19 is a schematic diagram showing two or more display panels of FIG. 1 in an “Alarm Clock” mode orientation with one or more image being rotated 180° degrees from the opposing image or images. Images can be stretched across multiple displays or displayed in individual display panels independently from one another;

FIGS. 20-22 are schematic diagrams showing various display panel configurations, including various sizes and shapes of display panels;

FIG. 23 is a block diagram of an example electronic book and some internal components thereof;

FIG. 24 is a flow chart showing some of the logic outlined in FIG. 23 for manipulation and control over orientation and presentation of media on each display.

### DETAILED DESCRIPTION OF THE PREFERRED EMBODIMENT

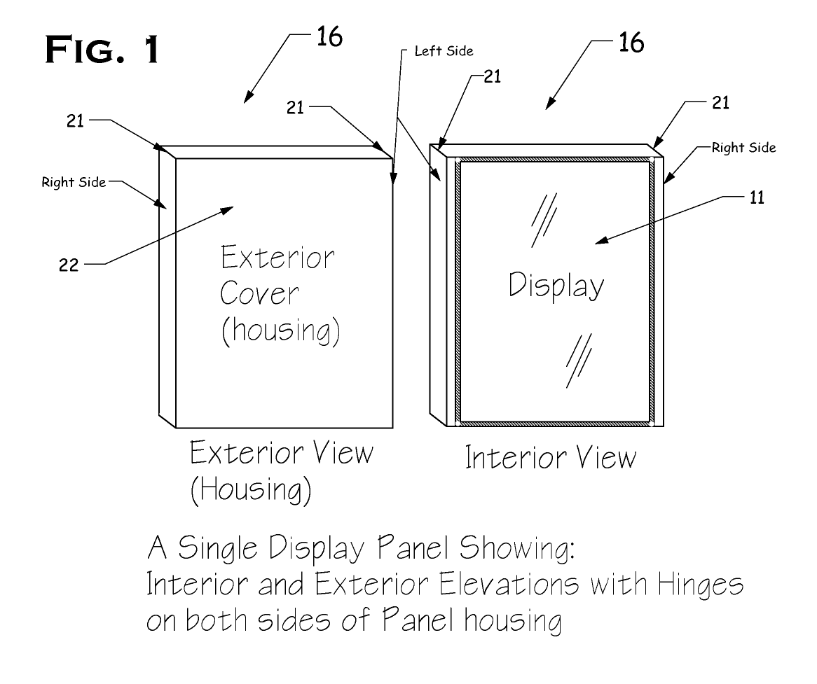

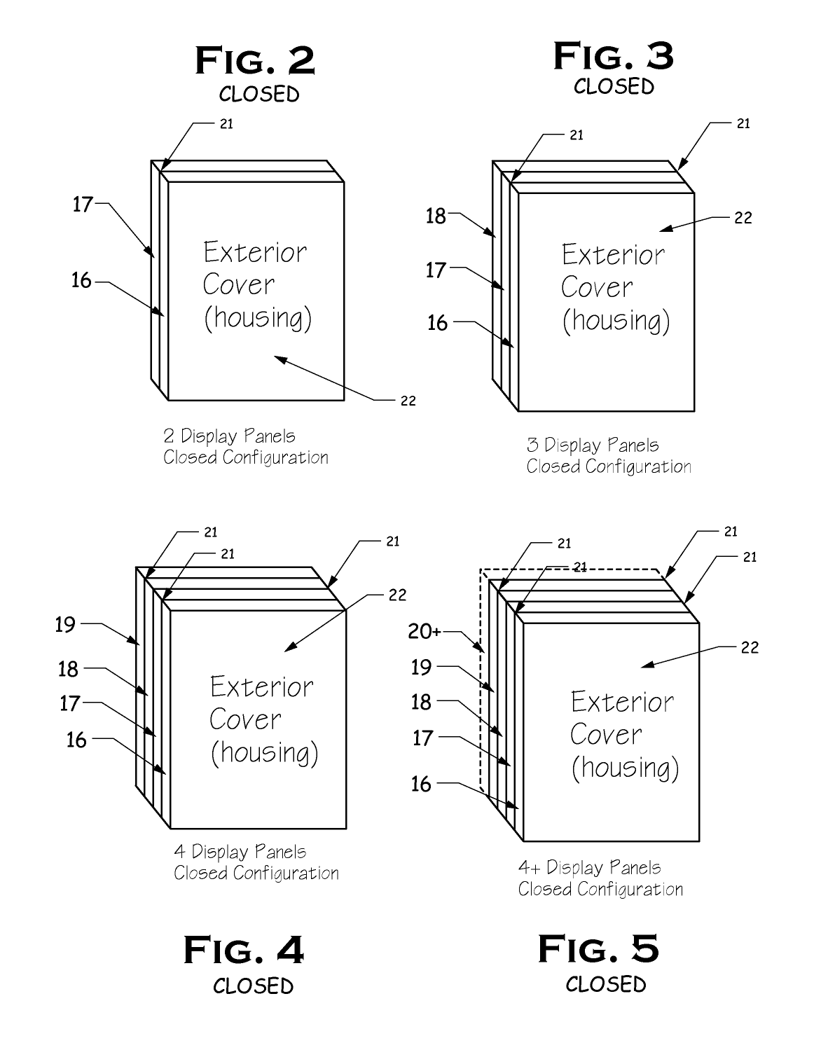

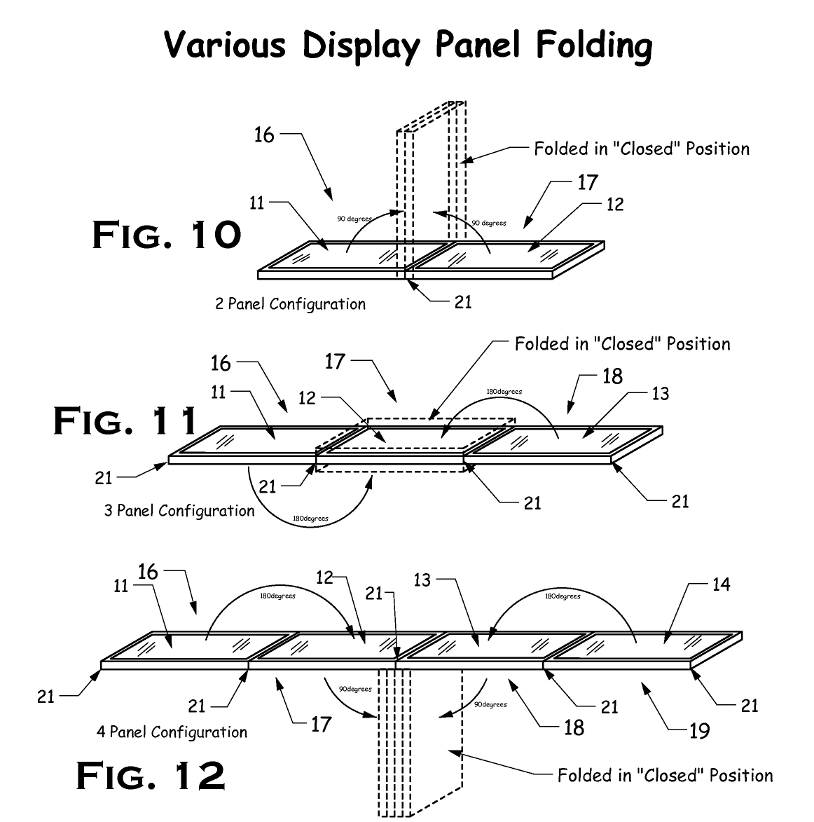

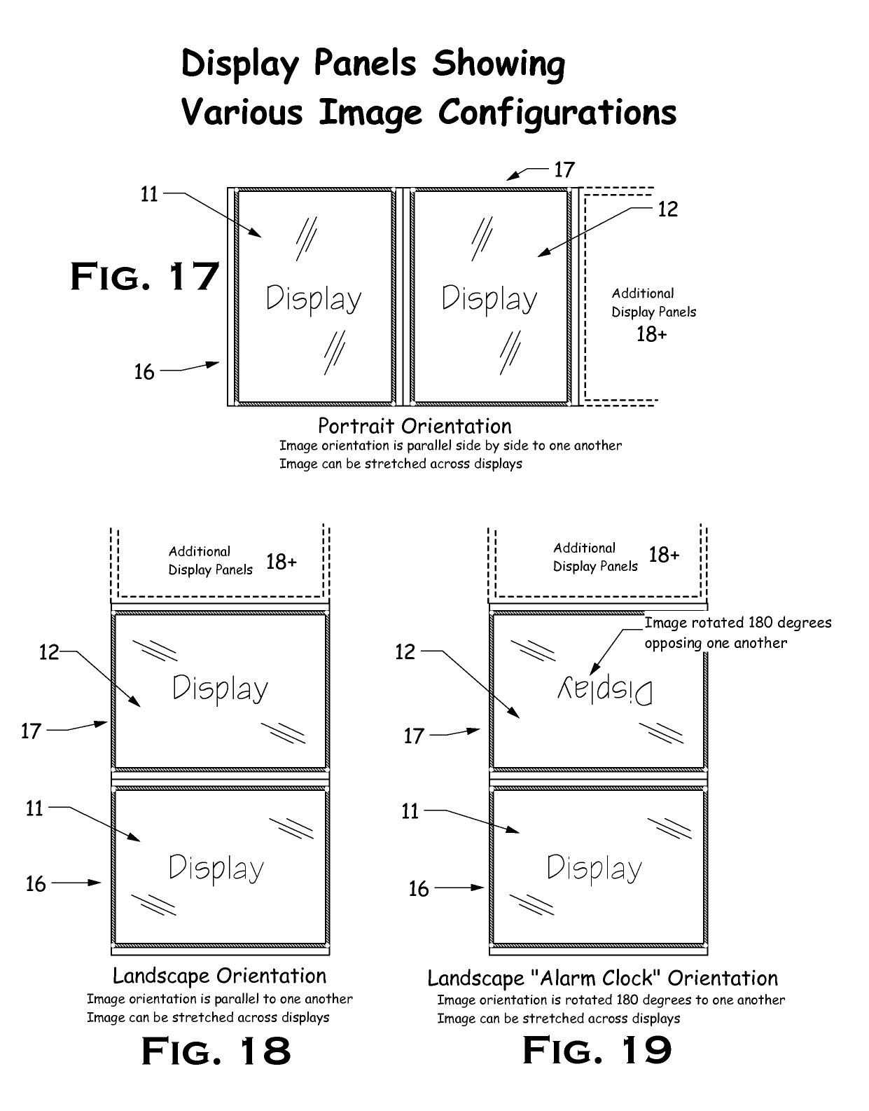

Referring to FIG. 1, and example of an electronic book display panel 16 is shown that can have, in one embodiment, a foldable configuration and, by hinging together additional display panels 17-19+, can be folded and arranged in various configurations. Specifically, the electronic book 16 may have a rigid lightweight metal or plastic housing 22 which can be hinged on either the right or left side of the panel housing 21 to additional display panels 17, 18. Display panel 16 can hinged to an additional display panel 17, which panel 16 or 17 can be rotated a full 0° degrees closed (FIG. 2) to a full 360° degree open position (FIG. 14) and can be stopped at any degree location in between. Wherein the touch screen display 11 can be viewed when open (FIGS. 7-9) and not when in a closed position (FIGS. 2-5). Additional display panels 17-19+ can be hinged to original display panel 16 and can communicate wirelessly to these other adjoining display panels 17-19+ or over a network.

FIG. 23 shows some internal components of the electronic book display panel 16, comprising various ports and connectors 38, optional solar collectors 30, solar charge circuitry 31, one or more DC batteries, one or more processors 33, electronic storage medium 34, Accelerometer 35, video accelerators to display components and connections 11-14+, and other auxiliary components such as speakers, mic, cameras, network cards, GPS, etc. 36.

The battery 32 powers one or more processors 33 within the housing 22. The processor accesses the electronic storage medium within the storage component 34. The electronic storage component 34 can be comprised but not limited to either a solid state storage or a disk-type storage. The storage medium can also be accessed remotely over a network.

If desired, the housing 22 may contain integrated solar panel collectors 30 which are connected to the solar charging circuitry 31 that has appropriate conversion, amplification, and filtering circuitry which is then connected to one or more rechargeable DC batteries 32, all components which are contained within the house 22.

FIG. 1 shows components consisting of a lightweight housing 22 of either plastic or metal wherein a display 11 is fastened. The display 11 may be, but not limited to, a back-lit liquid crystal display (LCD), or light emitting diode display (LED), or organic light emitting diode (OLED), or any other appropriate display technology.

Electronic files for books, journals, magazines, newspapers, text, image, video, music, as well as software programs, can be stored on the medium within the electronic storage component 34. The processor 33 controls and communicates with all components 32-36 and displays 11-15+, and communicates through signal input by user through a touch screen 23.

The accelerometer 35 within the housing 22 may provide signals to the processor 33 of angular acceleration. The purpose of angular acceleration is to rotate images within display 11 from a starting 0° degrees to either a 90° degree position or a 180° degree position by physical rotation of electronic book display panel by user in the clockwise or counterclockwise direction.

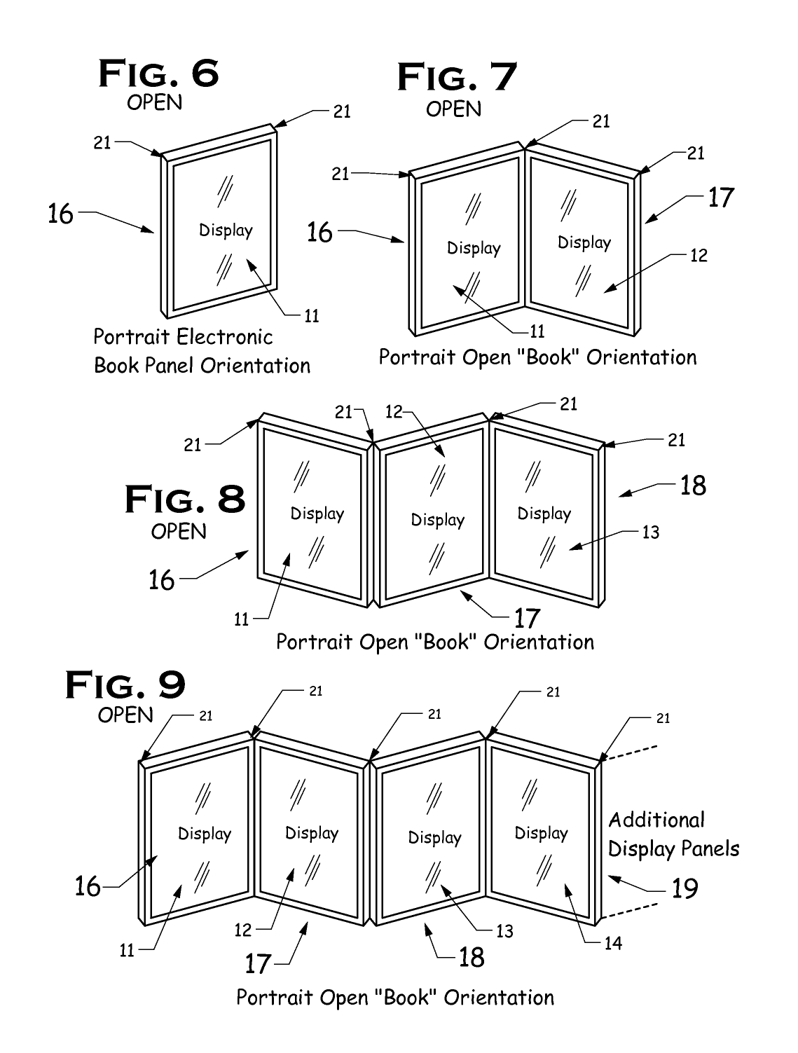

FIGS. 2-5 show folding of two or more display panels 16-19+ in folded closed positions, while FIGS. 6-9 show the various combinations of display panels 16-19+ folding in open “book” portrait display modes and orientations.

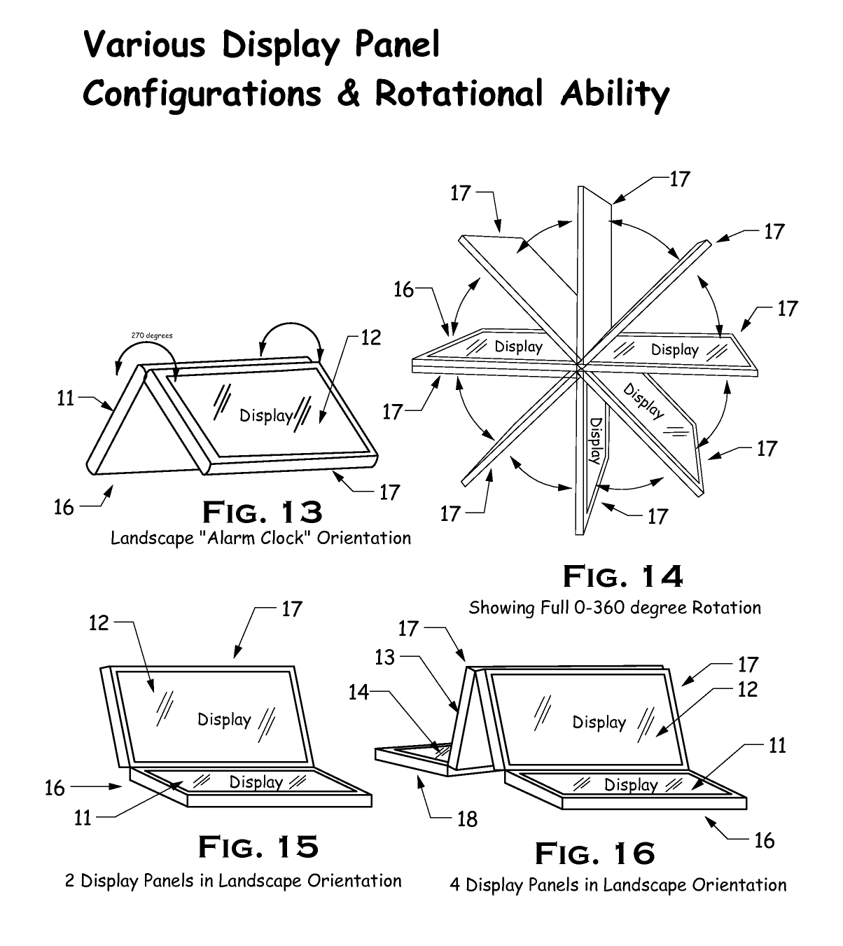

FIGS. 10-12 show folding and rotation of multiple display panels 16-19 from open positions to closed positions, where each display panel 16-19 can either extended and laid out flat for viewing and user interaction, or be folded back on one another for storing and ease in carrying the device.

FIG. 13 shows display panels 16, 17 in a landscape orientation and open to approximately 270° degrees, with images of displays 11, 12 opposing each other in a 180° degree rotation from one another. FIG. 14 shows display panels 16, 17, while display panel 17 has free and full rotation around the hinge axis 21 from 0° degrees, which is in a closed position with displays 11, 12 facing each other, to a full 360° degrees folded back onto the display panel 16 in an open position and configuration. Display panels 16, 17 can stopped and viewed at any rotational degree the user chooses.

FIG. 15 shows schematic diagram of display panels 16, 17 in landscape open mode, while FIG. 16 shows four display panels 16, 17, hinged together in landscape mode to display panels 18, 19, being set in landscape mode while the images on displays 13, 14 are oriented 180° degrees from images on displays 11, 12, or opposing views. This configuration allows for two or more users to operate the electronic book at the same time and interact together, for instance in a game-like fashion or for a teacher-student interaction.

In FIGS. 17-19, are schematic diagrams showing examples in which display panels 16, 17, plus additional display panels 18+ which can be arranged with their respective hinges 21 connected together, and display images on their respective display screens 11, 12+, depending on input signals by user or accelerometer. For example, FIG. 17 shows display panels 16 and 17 (plus any additional panels) which present images of respective media on display screens 11, 12. Images on displays 11, 12, can be “stretched” across multiple displays, thus enlarging the overall image. Or, if for example four display panels 16-19 are hinged and connected wirelessly, each display 11-14 can present one large image “stretched” across (or span across) all the displays 11-14, or each display can present a single page of an electronic book file, thus the user can see four total pages of an electronic book at once, or the user can have two or more electronic book files open at the same time, thus providing the viewer with two or more “open” electronic book files to read and view at the same time. The user, through software and input signal can determine how the images are viewed, manipulated, and orientated. Display panels 16-19+ do not have to be hinged to communicate with one another and can communicate and be connected wirelessly.

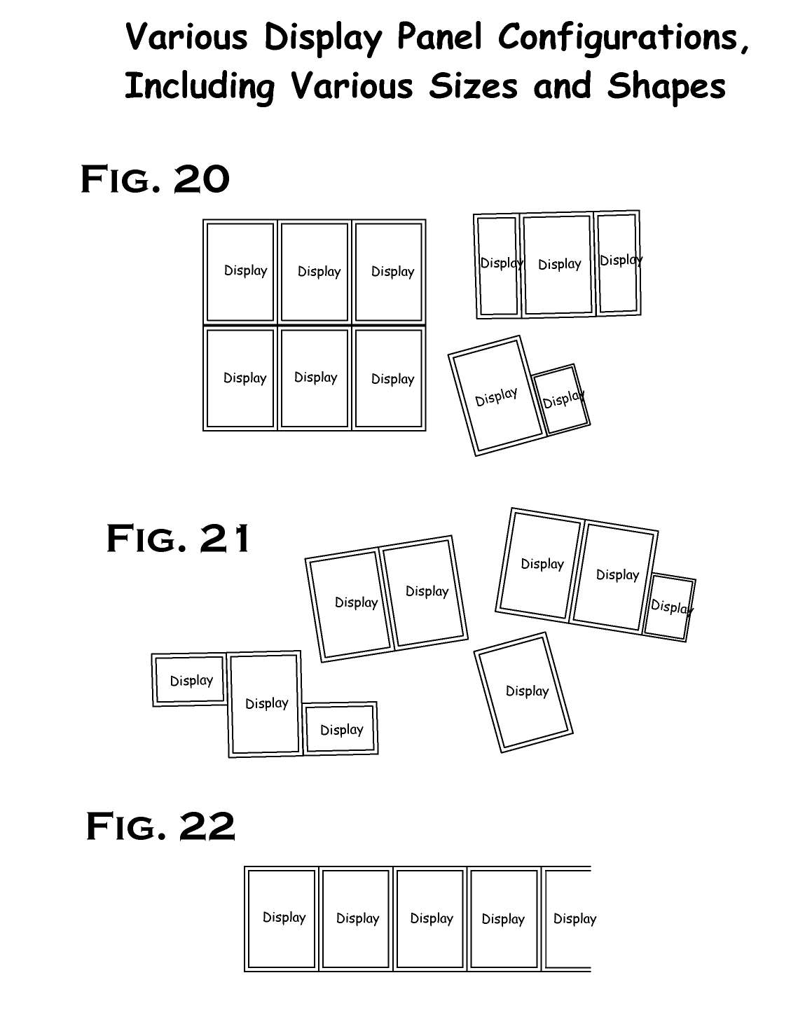

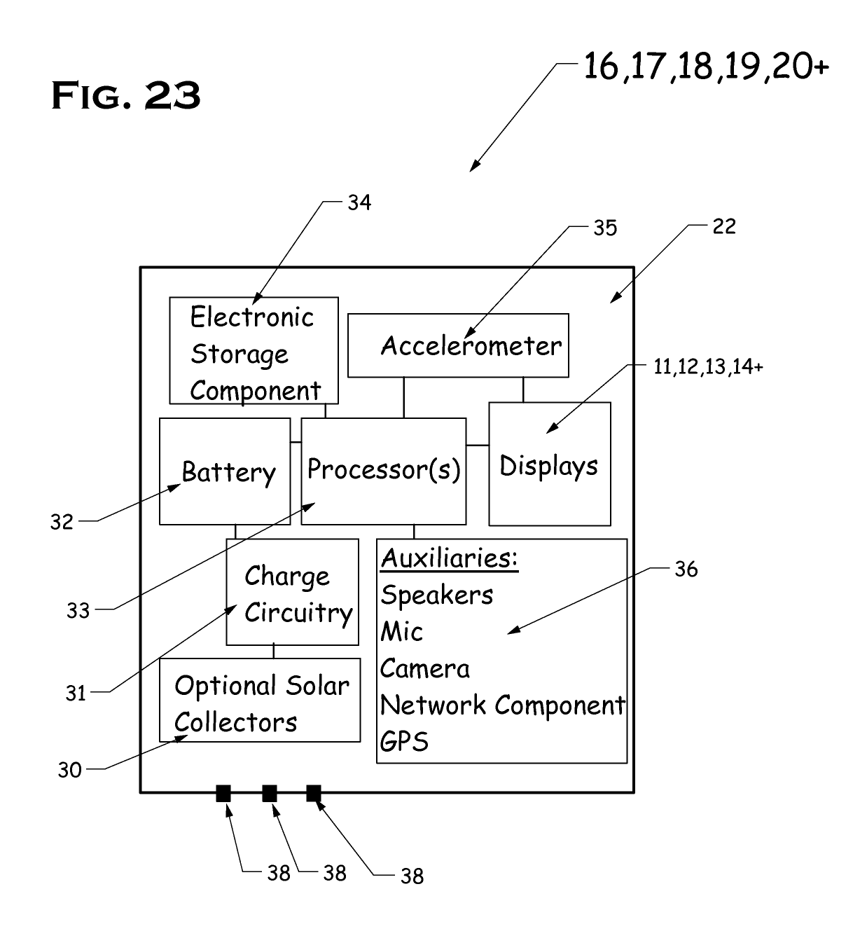

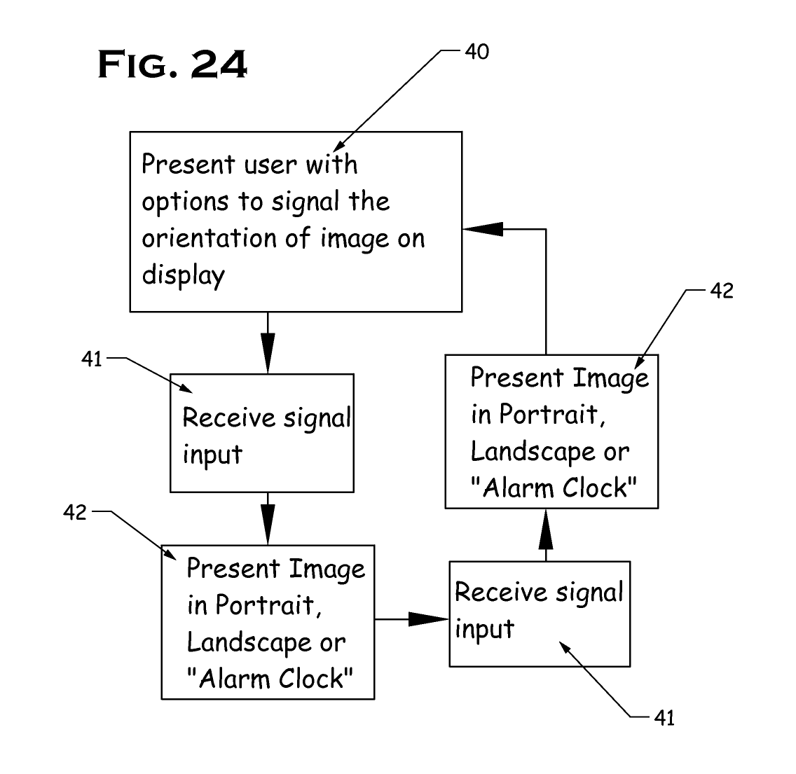

FIGS. 20-22 show various possible configurations of display panels 16+, and these configurations are not limited to by the number of display panels connected together by hinge or network, or by the orientation or configuration of the display panels themselves. For instance, a user, say a student, can do research on multiple display panels 16+ with each display panel 16 showing a separate page or image from an electronic book file or electronic journal file (or any other files or videos) thus providing the ability to view multiple image and video files all at once. For example, in a classroom setting, a teacher can communicate wirelessly through a network from one or more of his/her electronic book display panels 16, to one or more of each student's electronic book display panels 16.

A single image can be “stretched” across multiple displays 11+, thus enlarging the single image; or multiple electronic files of books, journals, magazines, text, video, etc., can be opened and viewed at the same time on as many individual display panels 16+ and in any combination or orientation that the user determines; and each and every display panel 16+ can communicate together with other display panels over a network.

FIG. 24 represents an example of logic 40-42 where the user is presented with options to signal the rotation of the image on the display 11 (and each individual display 11-15+) and to orient itself in a portrait orientation FIG. 17, or landscape orientation FIG. 18, or landscape “Alarm Clock” orientation FIG. 19. Signaling occurs through physical finger touch gestures directly onto the touch screen display 11, or by virtual electronic icons on the display 11 interface, or by physical rotation of the display panel(s) by the user which triggers the accelerometer 35 to rotate the image on the display 11. Each successive signal can change the image orientation.

It is to be understood that clockwise rotation may be used in lieu of counterclockwise rotation to reconfigure the display panels from FIG. 17 to either FIG. 18 or FIG. 19; or from FIG. 18 to either FIG. 17 or FIG. 19; or FIG. 19 to either FIG. 18 or FIG. 17.

While the particular ELECTRONIC BOOK WITH CONFIGURABLE DISPLAY PANELS is herein shown and described in detail, and it is understood that the subject matter which is encompassed by the present invention is limited only by the claims.

1. Electronic book panels comprising: a housing; a touch screen display supported in a housing; the housing have hinge capabilities on both right and left sides (two-sided); a digital processor within the housing which controls the presentation of images on displays and the sound and other features and other auxiliary components; a computer-reader storage medium accessible to the processor; electronic media files, which include but not limited to, books, magazines, journals, newspapers, video, sound (MP3, etc), text, and images, which are stored on the medium for presentation of the media within the displays that can be viewed in a 0° degrees portrait mode, or a 90° degrees landscape mode, or a 180° degrees “alarm clock” mode (one or more images rotated perpendicular or opposed to one another); the processor receiving a display orientation mode change signal on one or more display panels, this signal triggered either manually by a physical touch of a finger gesture by the user, or by voice command (see 8), or by touching an electronically generated graphical icon on the touch screen or by changing orientation automatically by the means of physical rotation either clockwise or counterclockwise of the display panel and thereby causing the accelerometer to rotate the image automatically.

2. The electronic book panels of claim 1, wherein the housing of display panel has hinging capabilities on both right and left sides (two-sided) which allows for multiple electronic book display panels to be assembled and joined together in various configurations. Also, the display panels themselves can be various in size and shape and thickness.

3. The electronic book panels of claim 1, wherein the hinging of display panels provides for folding and full rotational freedom of panels, from 0° degrees to a full 360° degrees rotation when two or more display panels are hinged together.

4. The electronic book panels of claim 1, wherein the two-sided hinging of display panels provides for multiple display panels to be hinged, 2, 3, 4, 5 or more panels can be hinged together.

5. The electronic book panels of claim 1, wherein the hinging of panels provide for multiple configurations and folding abilities. Display panels need not be hinged together to communicate wirelessly with adjacent or adjoining display panels or in a network.

6. The electronic book display panels of claim 1, wherein in response to display signal mode change the processor presents an image orientation of 0° degrees, 90° degrees, or 180° degrees within the display.

7. The electronic book display panels of claim 1, wherein the accelerometer within the housing and providing input signal to the processor which rotates image automatically to an orientation of 0°, 90° degrees, or 180° degrees within the display.

8. The electronic book display panels of claim 1, wherein the rotation of the image with the display can be made by a person's voice commands via a signal through a connected mic which signals the processor to rotate image.

9. The electronic book display panels of claim 1, comprising of at least on position signal receiver supported within the housing and communicates with processor and can be synchronized and connected wirelessly to other adjoined electronic book panels whether hinged together or not.

10. The electronic book display panels of claim 1, comprising multiple auxiliary components such as; GPS, Mic, camera, speakers, headphone jacks/ports, charging and power ports, and solar collecting and charging capabilities.

11. Method comprising: providing an electronic book display panel with opposed two or more display panels hinged together on a foldable housing; presenting an image format on each page in portrait (0° degrees) mode layout or landscape (90° degrees) mode layout or “Alarm Clock” (180° degrees) mode layout; upon receipt of mode change signal, presenting on display of choice an image in any mode the user selects by electronic input—whether by touch or sound—or physical rotation of display panel wherein the accelerometer signals processor to rotate the image either clockwise or counterclockwise.

12. The method of claim 11, wherein the mode change signal is generated by a person rotating the electronic book panel 90° degrees or 180° degrees.

13. The method of claim 11, comprising, upon receipt of the mode change signal, whether through touch screen gestures or software generated graphical icons on display, rotates the image of display panel 90° degrees or 180° degrees.
